(19) United States
(12) Patent Application Publication
(10) Pub. No.: US 2011/0319147 A1
(43) Pub. Date: Dec. 29, 2011

(54) MOBILE DEVICE CASE SLIDING RAIL AND LATCH

(75) Inventors: Fernando TAGES, Coral Springs, FL (US); Danny ACERO, Miramar, FL (US); Jorge SOTELO, Doral, FL (US)

(73) Assignee: A.G. FINDINGS & MFG. CO., INC., Fort Lauderdale, FL (US)

(21) Appl. No.: 13/160,295

(22) Filed: Jun. 14, 2011

Related U.S. Application Data
(60) Provisional application No. 61/357,700, filed on Jun. 23, 2010.

(51) Int. Cl. H04M 1/00

(52) U.S. Cl. 455/575.8

(57) ABSTRACT

A protection device for protecting a sliding cellular telephone. The cellular phone includes a first portion in slidable engagement with a second portion. The protection device includes a first protection cover for receiving the first portion of the cellular phone. The first protection cover includes a first pair of longitudinal side walls, where each longitudinal side wall includes a guide rail. The protection device also includes a second protection cover for receiving the second portion of the cellular phone. The second protection cover is slidably engagable with the first protection cover. The second protection cover includes a second pair of longitudinal side walls, where each of the second pair of side walls includes an inner surface and an outer surface and a groove disposed along the inner surface such that each guide rail is slidably engagable with a corresponding groove.

### CROSS-REFERENCE TO RELATED APPLICATION

This application is related to and claims priority to U.S. Provisional Patent Application Ser. No. 61/357,700, filed Jun. 23, 2010, entitled MOBILE DEVICE CASE SLIDING RAIL AND LATCH, the entirety of which is incorporated herein by reference.

### STATEMENT REGARDING FEDERALLY SPONSORED RESEARCH OR DEVELOPMENT

n/a

### FIELD OF THE INVENTION

The present invention relates to mobile device covers and more specifically to a protection device for multi-piece slider cellular phones.

### BACKGROUND OF THE INVENTION

In today's world, cellular telephones have become so popular that it is a rare event to see someone who does not own or use a cellular telephone. Cell phones are no longer just being used for voice communications, but also for data communication and data access such as email, text messaging, access to the Internet, and access to social networking sites like Facebook® and Twitter®. However, many users find themselves having to replace their phones, not because of any internal malfunctions, but because they are constantly dropping their phones leading to the phone's malfunction or resulting in scratches to the phone's outer surface, thereby degrading its aesthetic appearance.

Many cell phone users cover their phones with rubber or soft coverings, which lessen the impact of dropped phones. Different cell phone covers are designed to fit different makes and models. Thus, a cover for a Blackberry® Treo® would be shaped differently than a cover for an iPhone®. Each of these cell phone covers are typically a one-piece cover designed to conform to the shape and size of the phone and that slips over the phone, covering the back and side portions of the phone while allowing the screen and keyboard on the front of the phone to still be accessed by the user.

While many cell phones are one-piece devices, slider phones include two components in a sliding relationship with each other. Typically, the screen is on a first section of the phone and the keyboard is on another section. The two sections slide away from each other in opposing directions, either vertically, or horizontally, allowing the user to access the keyboard which may have been hidden when the phone is not in use and the two sections of the phone are positioned one on top of the other. Slider phones have become very popular, especially with younger users such as teenagers and college students. However, unlike the typical, one-piece cell phone covers, the covers for the slider phones have proven inadequate due to the unique design of the sliding-type of phones.

Existing covers for one-piece cell phones are not adaptable for slider phones since slider phones do not have any areas where the one-piece covers can attach to without impacting undesired force on the sliding phone's hinging/sliding mechanism. Thus, using two separate one-piece cell phone covers for slider phones is impractical. Other two-piece covers designed specifically for slider phones include an upper and a lower portion that are not connected to each other. Rather, each cover portion covers a corresponding portion of the slider phone. The upper portion covers the outer perimeter of the upper portion of the phone, i.e., the outer perimeter of the screen portion, while the lower portion covers the keyboard section of the slider phone.

However, this design has proven inadequate for a number of reasons. Because present slider phone covers are comprised of two discrete pieces, they do not prevent damage to the slider phone caused by the prying load between the two sliding parts of the phone. This prying effect, which imparts torque on the phone cover components, is known as the “oreo” effect and occurs when the upper and/or lower portions of the phone are twisted with respect to each other. This motion damages the sliding mechanism of the slider phone. Also, since the two portions of the cover are not connected to each other, they do not provide complete protection around the slider phone, i.e., at the portions of the phone where the upper and lower sections are connected to each other. This leads to cosmetic damage to the slider pone at the locations where the upper and lower sections are attached.

Therefore, what is needed is a cover for slider phones that alleviates the aforementioned problems with known two-piece slider phone covers.

### SUMMARY OF THE INVENTION

The present invention advantageously provides a method and apparatus for protecting slider-type cellular phones.

In one aspect of the invention, a protection device for a cellular phone is provided where the cellular phone includes a first portion in slidable engagement with a second portion. The protection device includes a first protection cover for receiving the first portion of the cellular phone. The first protection cover includes a first pair of longitudinal side walls, each longitudinal side wall including a guide rail. The protection device also includes a second protection cover for receiving the second portion of the cellular phone. The second protection cover is slidably engagable with the first protection cover. The second protection cover includes a second pair of longitudinal side walls, where each of the second pair of side walls includes an inner surface and an outer surface and a groove disposed along the inner surface such that each guide rail is slidably engagable with a corresponding groove.

In another aspect of the invention, a protection device for a cellular phone is provided where the cellular phone has a first portion in slidable engagement with a second portion. The protection device includes a first protection cover for receiving the first portion of the cellular phone and a second protection cover for receiving the second portion of the cellular phone, where the second protection cover is slidably engaged with the first protection cover. The first protection cover and the second protection cover slide horizontally in opposite directions with respect to each other up to a first separation distance apart. The protection devices also includes an extension slidingly engageable with the first protection cover and the second protection cover. The extension allows the first protection cover and the second protection cover to slide horizontally away from each other to a second separation distance, the second separation distance being greater than the first separation distance.

In yet another aspect of the invention, a method for protecting a cellular telephone is provided. The cellular telephone has a first portion in slidable engagement with a second portion. The method includes inserting the first portion of the cellular phone within a first protection cover, the first protection cover arranged to receive the first portion of the cellular phone. The first protection cover includes a first pair of longitudinal side walls, each longitudinal side wall including a guide rail. The method also includes inserting the second portion of the cellular phone within a second protection cover, the second protection cover arranged to receive the second portion of the cellular phone. The second protection cover is slidably engagable with the first protection cover. The second protection cover includes a second pair of longitudinal side walls, each of the second pair of side walls including an inner surface and an outer surface and a groove disposed along the inner surface such that each guide rail is slidably engagable with a corresponding groove.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a top view of a slider cell phone protection cover constructed in accordance with the principles of the present invention;

FIG. 2 is the slider cell phone protection cover of FIG. 1 with a slider cell phone;

FIG. 3 is a side view of the slider cell phone protection cover of FIG. 1 showing the sliding relationship between the top and bottom portions of the protection cover;

FIG. 4 is a section view taken through section A-A in FIG. 3;

FIG. 5 is a partial top, perspective view of the slider cell phone protection cover of FIG. 1;

FIG. 6 is an exploded view of the slider cell phone protection cover of FIG. 1;

FIG. 7 is a top perspective view of an alternate embodiment of the slider cell phone protection cover of the present invention;

FIG. 8 is a top perspective view of the slider cell phone protection cover of FIG. 7 holding a slider cell phone and showing the sliding relationship between the top and bottom portions of the protection cover;

FIG. 9 is a side view of the slider cell phone protection cover of FIG. 7 showing the sliding relationship between the top and bottom portions of the protection cover;

FIG. 10 is a bottom perspective exploded view of the slider cell phone protection cover of FIG. 7;

FIG. 11 is a top view of an alternate embodiment of the slider cell phone protection cover of the present invention; and

FIG. 12 is an exploded bottom view the slider cell phone protection cover of FIG. 11.

### DETAILED DESCRIPTION OF THE INVENTION

Before describing in detail exemplary embodiments that are in accordance with the present invention, it is noted that the embodiments reside primarily in combinations of apparatus components related to implementing a protection cover for slider cellular phones. Accordingly, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a protection device for a slider cellular phone that includes a first protection cover for receiving a first portion of the slider cellular phone and a second protection cover for receiving the second portion of the slider cellular phone, where the second protection cover is in an interlocked sliding relationship with the first protection cover. During the sliding motion, the first and second components of the protection device are interlocked with each other thus preventing undesired torque due to twisting of the first and second protection covers.

The present disclosure will be understood more fully from the detailed description given below and from the accompanying drawings of particular embodiments of the invention which, however, should not be taken to limit the invention to a specific embodiment but are for explanatory purposes.

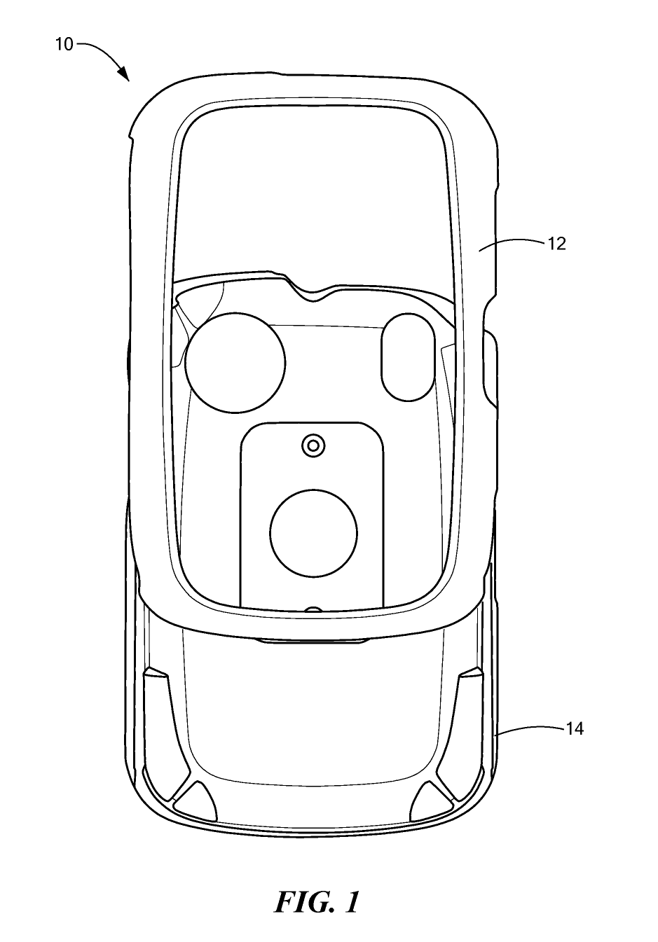

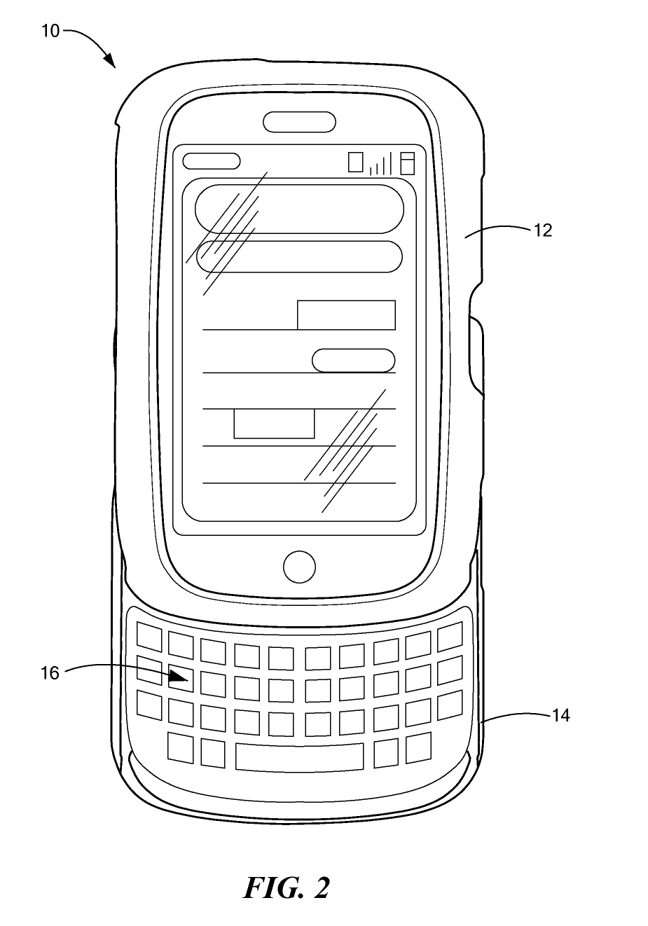

Referring now to the drawing figures in which like reference designators refer to like elements, there is shown in FIG. 1 an exemplary configuration of a slider phone protection cover 10 according to an embodiment of the present invention. In one embodiment, protection cover 10 includes a top portion 12 and a bottom portion 14. Top portion 12 receives the top section of a sliding cellular telephone (shown in FIG. 2) and bottom portion 14 receives the bottom section of a sliding cellular telephone. Top portion 12 and bottom portion 14 can be made of a substantially rigid material. The top and bottom portions of a sliding or “slider” cellular telephone move either vertically or horizontally with respect to each other. As used herein, the term “vertically” refers to an arrangement where the sides of top portion 12 and bottom portion 14 are longer than the upper and lower edges of each portion such that the top portion and bottom portion slide along the longer sides. The term “horizontally” as used herein, refers to an arrangement where the sides of top portion 12 and bottom portion 14 are shorter than the upper and lower edges of each portion such that the top portion and bottom portion slide along the shorter sides. The top portion of the slider phone typically includes a screen and the bottom portion typically includes the keyboard. Moving the top portion with respect to the bottom portion allows the cell phone user to access the phone's keyboard while still viewing the phone screen. The embodiment depicted in FIG. 1 is receives and protects slider phones having top and bottom portions that separate vertically with respect to each other. Other embodiments of the invention can be used with slider phones that have upper and lower components that separate horizontally with respect to each other.

Protection cover 10 can be made of any suitable protection material such as rubber, hard or soft plastic, or a combination of these materials that will protect the phone's outer surfaces. In one embodiment, the materials are substantially rigid. Top section 12 is in a vertical sliding relationship with lower section 14. Protection cover 10 receives a slider cell phone 16, as shown in FIG. 2. Top portion 12 receives the top section of the slider phone and bottom portion 14 receives the bottom portion of the phone. While known slider phone protection covers include an upper section and a lower section that are connected to the phone but are not connected to each other, thus allowing the upper and lower cell phone sections to be inadvertently twisted with respect to each other, the protection cover 10 of the present invention advantageously includes two portions that are not separately and individually connected to the phone but instead cover respective sections of the phone and slide with respect to each other while maintaining contact with each other through the sliding process. This eliminates any potential twisting and torque that might be imparted upon the cell phone portions.

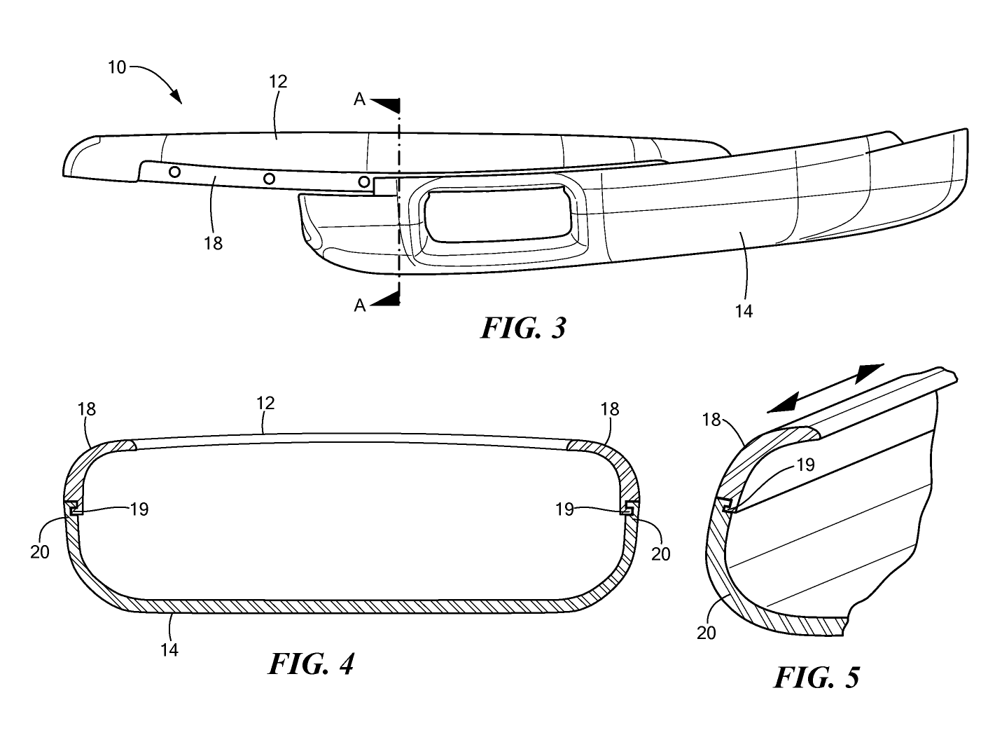

FIG. 3 provides a side view of slider cell phone protection cover 10, showing how the top section 12 and bottom section 14 maintain contact with each other during the sliding process. Top section 12 includes a glide rail 18 along each side of top section 12. Guide rail 18 may be formed as a part of top section 12. Thus, in one embodiment, guide rail 18 forms an extension of the lower edges of the sides of top section 12. In another embodiment, guide rail 18 is removably attached to the lower edges of top section 12. Guide rail 18 allows top section 12 to slide smoothly back and forth along the surface of bottom section 14. Guide rail 18 also serves to connect top section 12 to bottom section 14 rather than allowing the top and bottom sections to separately attach directly to the slider phone 16. Thus, when top section 12 and bottom section 14 are moved with respect to each other, top section 12 and bottom section 14 maintain contact with each other thereby preventing the top and bottom portions of slider phone 16 from twisting with respect to each other or being separated from each other. This twisting motion, also known as “the oreo effect”, can lead to phone damage.

FIG. 4 illustrates a section view of an exemplary protection cover 10 of the present invention taken through section A-A in FIG. 3. FIG. 4 shows the mating arrangement that allows top section 12 to interlock with, and glide smoothly with, respect to bottom section 14. Top section 12 includes a pair of guide rails 18, where each guide rail 18 mates with a corresponding longitudinal groove railing 20 formed along the inner side wall of bottom section 14. Each guide rail 18 includes an outwardly-projecting tongue 19 that engages elongated groove railing 20. Advantageously, the engagement of tongue 19 within groove railing 20 as top section 12 and bottom section 14 slide with respect to each other prevents the top and bottom portions of slider phone 16 from twisting with respect to each other or being separated from each other. It is within the scope of the invention to include guide rail 18 along the edges of bottom section 14 and longitudinal groove 20 that receives guide rail 18 to be located along each side wall of top section 12.

FIG. 5 is another view showing the mating of guide rail 18 with groove railing 20. From this view, the engagement of tongue 19 within groove railing 20 is shown. Tongue 19 projects laterally from guide rail 18 and “catches” an elongated groove in groove railing 20 as top section 12 and bottom section 14 slide up and down with respect to each other. Any twisting of top section 12 and bottom section 14, and the phone portions they house is avoided due to the interaction that occurs at the point where tongue 19 is retained within groove railing 20.

Top portion 12 has a smaller width than the width of bottom portion 14 thus allowing each guide rail 18 to slide within its corresponding groove railing 20. Groove railing 20 is an elongated groove cut along the interior side wall of bottom portion 14. Thus, groove 20 is bounded by an upper and lower lip. Guide rail 18 includes outwards extending substantially horizontal tongue 19 that fits into the groove of groove railing 20. Thus, as top portion 12 slides along bottom portion 14, tongue 19 of groove railing 18 is retained within the groove of groove railing 20 which is formed on the interior wall of bottom portion 14. Because the elongated groove of groove railing 20 is bordered above and below by the interior wall of bottom portion 14, guide rail 18 is retained within groove railing 20. Further, the interlocking of guide rail 18 within groove railing 20 prevents the side-to-side twisting or “OREO” effect that can damage cover 10.

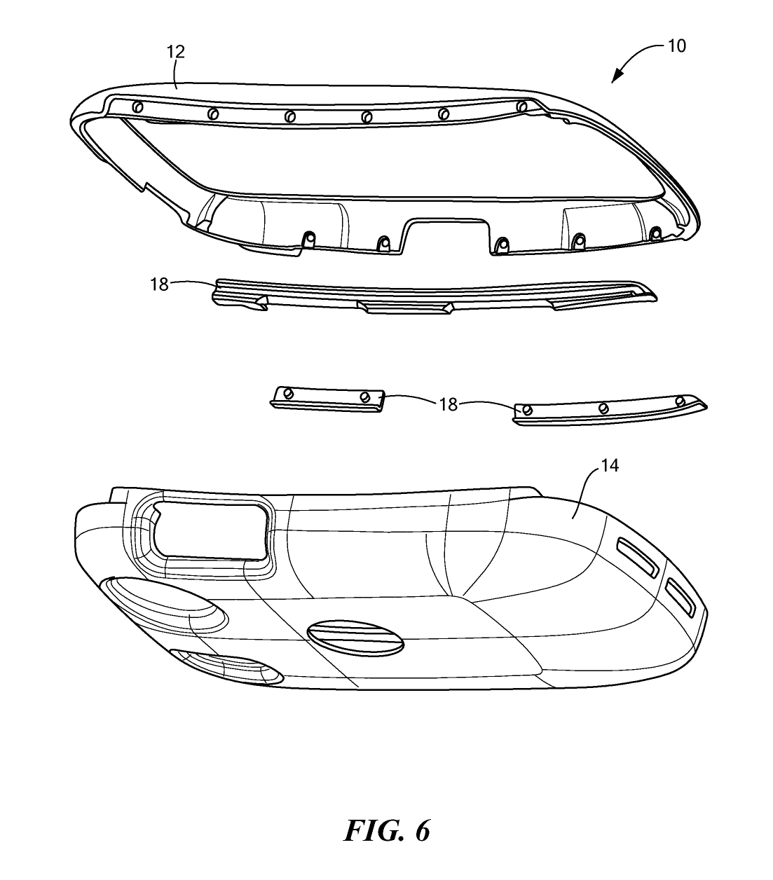

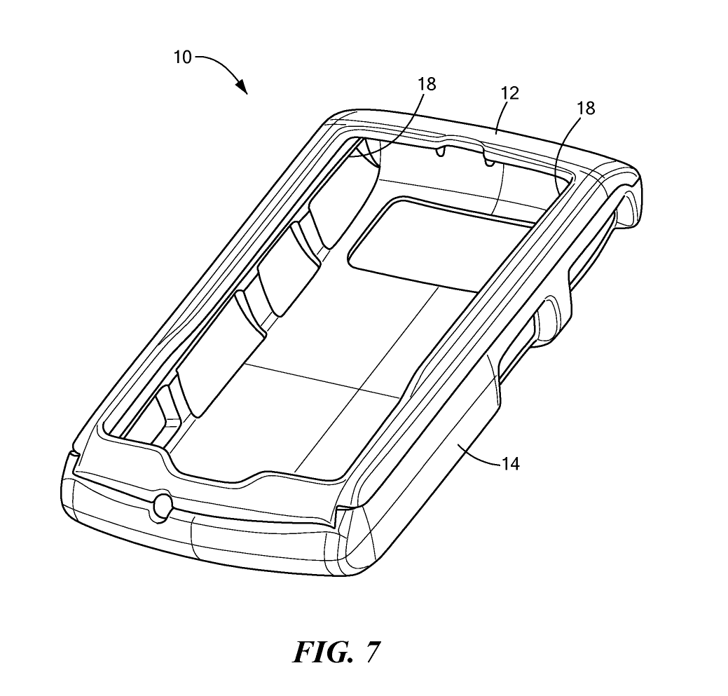

Guide rail 18 may be formed as a part of the bottom edges of top section 12 or may be a separate element that attaches to top section 12. Similarly, the longitudinal groove might be a railing with interior grooves that is attached to the longitudinal sides of bottom section 14 and that receives guide rail 18, as shown in FIG. 6. In FIG. 6, guide rail 18 is formed of one continuous piece designed to fit along each longitudinal edge of top portion 12. However, it is contemplated that guide rail 18 can be formed from two or more sections rather than one in order to allow for gaps or apertures in cover 10, which accommodates ports in cell phone 16 for receiving wire connections and the like. Similarly, a longitudinal groove railing 20 can be one piece or two pieces (as shown) to accommodate gaps or apertures in bottom section 14. Groove railing 20 can be formed as a part of the side longitudinal walls of bottom section 14 or may be a separate component designed to be attached to the longitudinal sides of bottom section 14. In FIG. 6, the outer side of groove railing 20 is shown. The inner side of groove railing 20 includes the actual grooves which are adapted to receive a corresponding guide rail 18.

The interaction between top portion 12 and bottom portion 14 results in a retention of guide railing 18 within groove railing 20 in a direction which is orthogonal to the direction of motion of top portion 12 with respect to bottom portion 14. Further, when a portable device is inserted within cover 10, the portable device prevents the sides of top portion 12 and bottom portion 14 from bowing together, which might otherwise result in unwanted separation of top portion 12 from bottom portion 14. Instead, the portable device tends to exert outward, transverse pressure upon the sides of top portion 12 and bottom portion 14 thus further securing each guide rail 18 within their respective groove railing 20.

In one exemplary embodiment, guide rail 18 can be made of a resin such as polycarbonate (“PC”) resin or polyoxymethylene (“POM”) resin. Groove railing 20 can also be made of PC resin or POM resin. In one embodiment, the guide rail 18 is made of a different resin than groove railing 20 in order to reduce friction that may occur during the sliding motion of top section 12 and bottom section 14 with respect to each other. By using different resin combinations for guide rail 18 and groove railing 20, wear of cover 10 that might occur after extended use is reduced.

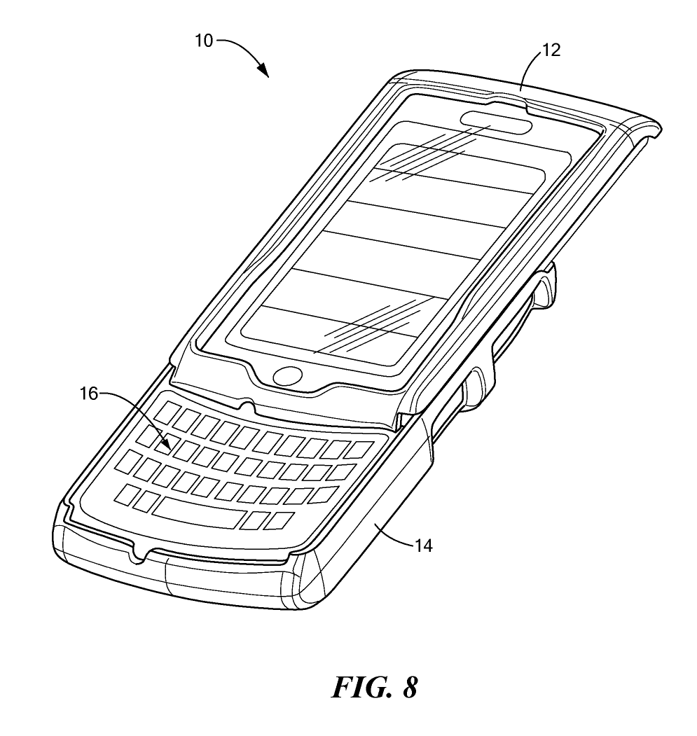

In FIGS. 7 and 8, another embodiment of the present invention is shown. In this embodiment, top portion 12 of protective cover 10 includes a pair of guide rails 18 that are removably attached to the bottoms of the two longitudinal edges of top portion 12. In FIGS. 7 and 8, top portion 12 rests upon bottom portion 14. Guide rails 18 are slidably engaged within their respective longitudinal grooves in bottom portion 14. Each longitudinal groove is situated along the interior longitudinal side wall of bottom portion 14. Each groove is essentially a cut-out of the interior side walls of bottom section 14. Thus, when guide rails 18 are slidably engaged within their respective grooves, the top portion 12 and the bottom portion 14 cannot be pulled apart by upward or downward pressure because the interior side walls of the bottom section 14 form an upper and lower ridge, prevent this from occurring.

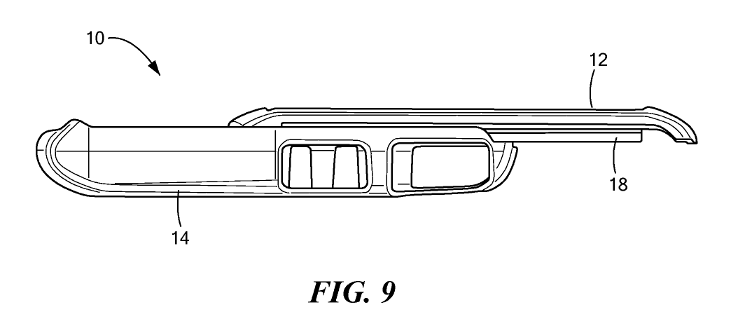

As shown in FIG. 9, top portion 12 glides vertically with respect to bottom portion 14 by the mating of guide rails 18 and their corresponding longitudinal grooves 20 (not shown in FIG. 9) in the same manner as described above with respect to the earlier embodiment (FIGS. 1-3). Thus, guide rails 18 and their ability to mate with corresponding longitudinal grooves allow for the top and bottom sections to move smoothly in a vertical (or horizontal) manner. Guide rails 18 and their corresponding grooves also serve as a latching mechanism, preventing the top cover 12 and the bottom cover 14 from being separated or from being twisted with respect to each other.

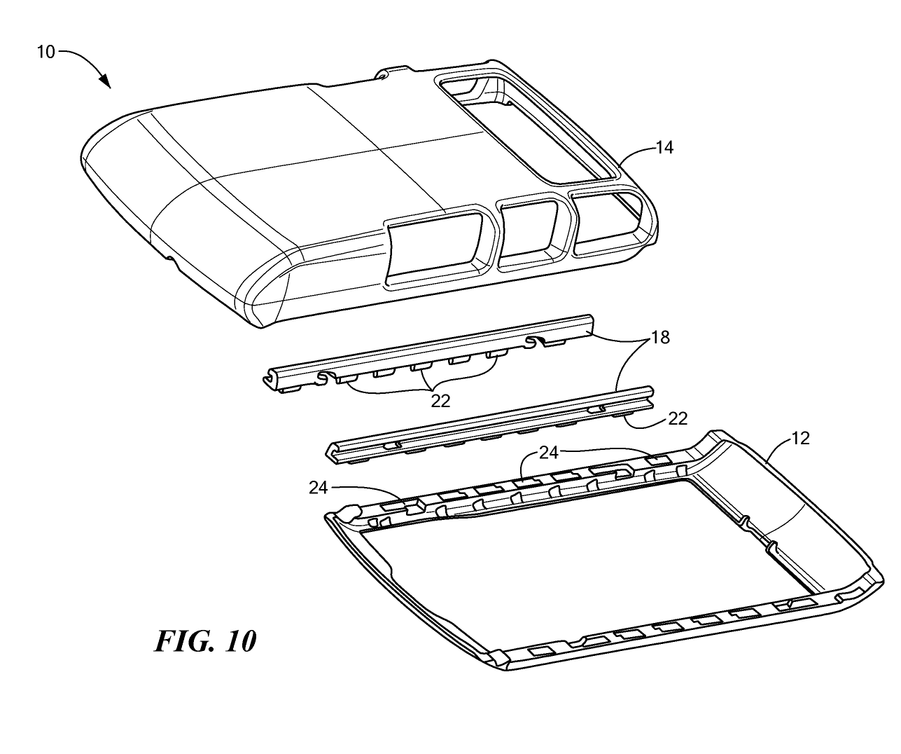

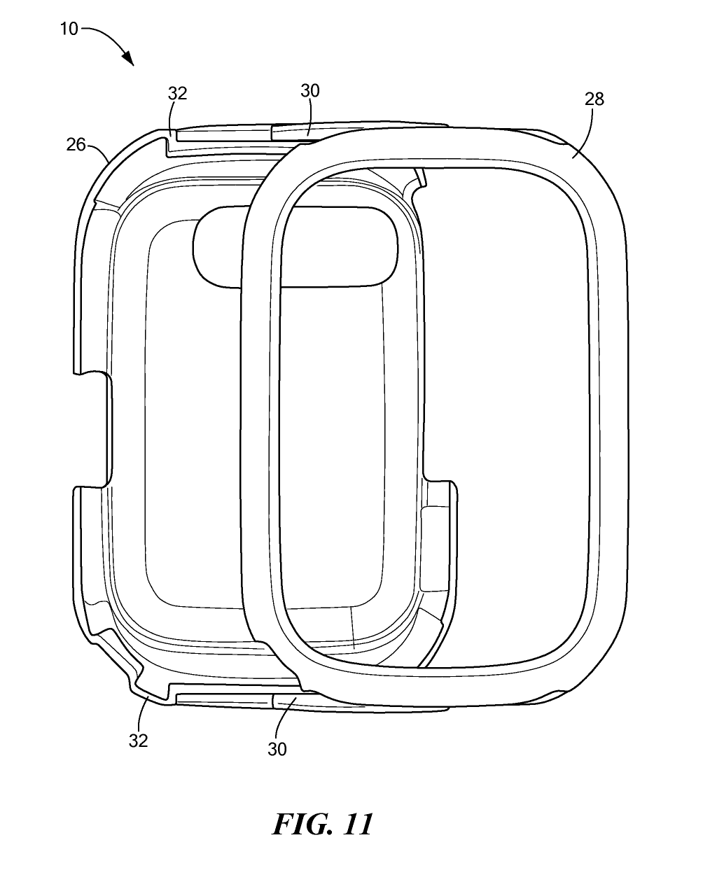

In FIG. 10, removable guide rails 18 are shown. In this embodiment, guide rails 18 include a series of protrusions 22 that mate with corresponding notches 24 along the longitudinal edges of top portion 12. The protrusion/notch system shown in FIG. 10 is just one way of attaching the guide rails 18 to top portion 12. It is within the scope of the invention to use other methods to attach the guide rails to the top portion 12. As in the previously described embodiment, each guide rail 18 slides within its corresponding groove 20 located in bottom portion 14, thus allowing the upper and lower sections of the slider phone 16 to be moved vertically with respect to each other while preventing said upper and lower sections from twisting. The twisting of the cell phone sections is prevented because the top portion 12 remains in constant contact with bottom portion 14 as the portions are moved in a vertical direction with respect to each other. Thus, the guide rails 18 serve as both a guiding mechanism to assure the top portion 12 and bottom portion 14 maintain their vertical orientation and a latching mechanism, connecting the top and bottom portions together instead of attaching directly to the slider phone 16.

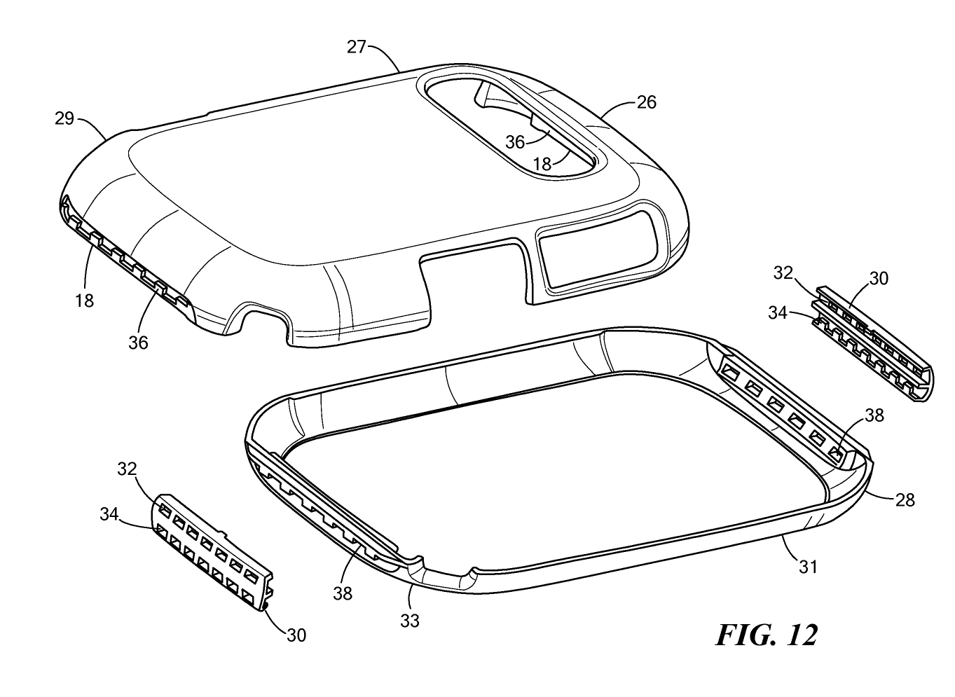

FIGS. 11 and 12 illustrate another embodiment of the invention. The embodiment in FIGS. 11 and 12 shows a protective cover 10 adapted to protect a slider phone 16 that has separate components that move horizontally with respect to each other rather than vertically. When used to describe how the separate components of protective cover 10 move with respect to each other, the terms “horizontally” as used herein, shall mean that when the portions of protective cover 10 are separated, the longer edges of protective cover 10 are separated from each other, while the shorter edges remain in contact. “Vertically” shall mean that, when the portions of protective cover 10 are separated, the longer edge of one portion glides along the other portion and do not separate. Instead, the shorter edges separate and move in opposite directions.

Horizontal slider phone 16 includes a left section and a right section, where one of the two sections includes a keyboard and the other section includes the screen. Thus, the user uses the horizontal slider phone 16 by separating the two sections laterally such that a left section 26 is separated from a right section 28 by a first distance. The protective cover 10 depicted in FIGS. 11 and 12 includes a left or first section 26 that is slidably engaged with a right or second section 28. The protective cover 10 shown in FIGS. 11 and 12 may be slidably attached to each other in the same manner as described above with respect to the protective cover 10 for the vertical slider phone 16. Thus, for example, left section 26 may include guide rails 18 (FIG. 12) on the bottom edges of the upper and lower transverse sides, which mate with corresponding grooves on the top edges of the upper and lower transverse sides of the right section 28. Alternately, the guide rails 18 can be located on the top edge of the upper and lower transverse sides of the right section 28 while the corresponding groove in which the guide rails 18 are slidably received may be located on the bottom edges of the upper and lower transverse sides of left section 26.

In another embodiment, protective cover 10 includes an extension mechanism that allows left section 26 and right section 28 slide away from each other a second distance, where the second distance is greater than the first distance, i.e., greater than the distance apart without the extension mechanism. Left section 26 and right section 28 are connected by two extension sliders 30 disposed between the upper and lower transverse ends of left section 26 and right section 28. For simplicity, “left section” or “first section” shall refer to the lower half 26 of horizontal protective cover 10 and “right section” or “second section” shall refer to the upper half 28 of horizontal protective cover 10. The first and second sections need not be in this particular orientation, i.e., the left section 26 may be the upper half of cover 10 while the right section 28 might be the lower half of cover 10.

The aforementioned extension mechanism includes a series of extension sliders and receiving ports. Extension sliders 30, best seen in FIG. 12, include an upper row of apertures 32 and a lower row of apertures 34. Left section 26 includes a first upper region 27 and a first lower region 29, where first upper region 27 and first lower region 29 each include upper and lower receiving ports 36, respectively. Upper and lower receiving ports 36 each include a set of teeth sized to slidingly engage upper apertures 32 located in each extension slider 30. Similarly, right section 28 also includes a first upper region 31 and a second lower region 33, each including upper and lower receiving ports 38. The lower row of apertures 34 of each extension slider 30 receive corresponding teeth of upper and lower receiving ports 38. Thus, extension sliders 30 join left section 28 with right section 26. In use, as right section 28, containing the right portion of horizontal sliding phone 16, is pulled horizontally to the right with respect to left section 26, the teeth of upper receiving port 36 catch the upper row of apertures 32 of extension slider 30. Thus, extension slider 30 is dragged to the right in the same direction as upper section 28. It is within the scope of the present invention to utilize different ways to connect left section 26 to right section 28 in order to allow the sections to move horizontally with respect to each other.

Another feature of sliders 30 are their ability to allow the left section 26 and right section 28 to be extended beyond the distance that guide rails 18 and their corresponding grooves would allow the left and right sections to be extended without sliders 30. Normally, left section 26 and right section 28 are extended a first distance as long as guide rails 18 remain in their respective grooves. If separated further, the respective cover sections are no longer directly connected to each other. This might be acceptable if the left and right sections of the horizontal slider phone 16 that has been inserted into protective cover 10 cannot be separated beyond this specified distance. Advantageously, sliders 30 allow the left section 26 and right section 28 of protective cover 10 to be extended beyond the first distance, to a second separation distance.

In use, as the left and right sections of protection cover 10 are separated, sliders 30 move along both the lower row of apertures 34 of left section 26 and the upper row of apertures 32 on right section 28. Thus, as right section 28 is being pulled toward the right, sliders 30 travel in the same direction while maintaining contact with both sections. At a certain point, each guide rail 18 on right section 28 reaches the end of its corresponding groove on left section 26 thus preventing the guide rails 18 from moving any further. However, right section 28 continues to move further right as upper teeth 36 catch their corresponding upper row of apertures 32 of slider 30 thus allowing right section 28 to continue to extend to the right. In this fashion, sliders 30 permit the right section 28 to extend further beyond the original coverage area of protective cover 10 (without the use of sliders 30) while allowing engagement of the left cover 26 and the right cover 28 to be distributed evenly. Sliders 30 and sections 26 and 28 may also includes stops to prevent the overextension of left section 26 and right section 28 when they are being moved away from each other.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A protection device for a cellular phone, the cellular phone having a first portion in slidable engagement with a second portion, the device comprising:
a first protection cover for receiving the first portion of the cellular phone, the first protection cover including a first pair of longitudinal side walls, each longitudinal side wall including a guide rail; and
a second protection cover for receiving the second portion of the cellular phone, the second protection cover slidably engagable with the first protection cover, the second protection cover including a second pair of longitudinal side walls, each of the second pair of side walls including an inner surface and an outer surface and a groove disposed along the inner surface such that each guide rail is slidably engagable with a corresponding groove.

2. The protection device of claim 1, wherein the guide rail is formed of a first material and the groove is formed of a second material, the first material being different from the second material.

3. The protection device of claim 1, wherein each guide rail includes an outwardly projecting tongue sized to slidably engage with the corresponding groove.

4. The protection device of claim 1, wherein each guide rail is formed as part of its corresponding longitudinal side wall.

5. The protection device of claim 1, wherein each guide rail is attached to the corresponding side wall.

6. The protection device of claim 1, the first protection cover is a top protection cover for receiving a top section of a cellular phone and the second protection cover is a bottom protection cover for receiving a bottom section of a cellular phone, wherein the top protection cover has a first upper side and first lower side coupled to the first side rails and the bottom protection cover has a second upper side and second lower side coupled to the second side rails, lengths of the first upper side, first lower side, second upper side and second lower side being shorter than lengths of the first and second side rails.

7. The protection device of claim 6, wherein the top protection cover and the bottom protection cover maintain contact with each other when sliding with respect to each other.

8. The protection device of claim 1, wherein the first protection cover and the second protection cover are made of a substantially rigid material.

9. The protection device of claim 2, wherein the first material is one of polycarbonate resin and polyoxymethylene resin and the second material is the other of polycarbonate resin and polyoxymethylene resin.

10. A protection device for a cellular phone, the cellular phone having a first portion in slidable engagement with a second portion, the device comprising:
a first protection cover for receiving the first portion of the cellular phone;
a second protection cover for receiving the second portion of the cellular phone, the second protection cover slidably engaged with the first protection cover, the first protection cover and the second protection cover slide horizontally in opposite directions with respect to each other up to a first separation distance apart; and
an extension slidingly engageable with the first protection cover and the second protection cover, the extension allowing the first protection cover and the second protection cover to slide horizontally away from each other to a second separation distance, the second separation distance being greater than the first separation distance.

11. The protection device of claim 10, wherein the first and second protection covers each have a first end region and a second end region, the extension comprising:
a first top receiving port located on the first end region of the first protection cover and a second top receiving port located on the first end region of the second protection cover;
a first bottom receiving port located on the second end region of the first protection cover and a second bottom receiving port located at the second end region of the second protection cover;
a first sliding member slidably engaged to the first and second top receiving ports; and
a second sliding member slidably engaged to the first and second bottom receiving ports.

12. The protection device of claim 11, wherein the first top receiving port and the second top receiving port maintain contact with the first sliding member and the first bottom receiving port and the second bottom receiving port maintain contact with the second sliding member when the first protection cover and the second protection cover slide horizontally with respect to each other.

13. A method for protecting a cellular telephone, the cellular telephone having a first portion in slidable engagement with a second portion, the method comprising:
inserting the first portion of the cellular phone within a first protection cover, the first protection cover arranged to receive the first portion of the cellular phone, the first protection cover including a first pair of longitudinal side walls, each longitudinal side wall including a guide rail; and
inserting the second portion of the cellular phone within a second protection cover, the second protection cover arranged to receive the second portion of the cellular phone, the second protection cover slidably engagable with the first protection cover, the second protection cover including a second pair of longitudinal side walls, each of the second pair of side walls including an inner surface and an outer surface and a groove disposed along the inner surface such that each guide rail is slidably engagable with a corresponding groove.

14. The method of claim 13, wherein the guide rail is formed of a first material and the groove is formed of a second material, the first material being different from the second material.

15. The method of claim 13, wherein each guide rail includes an outwardly projecting tongue sized to slidably engage with its corresponding groove.

16. The method of claim 13, wherein each guide rail is formed as part of the corresponding longitudinal side wall.

17. The method of claim 13, wherein each guide rail is attached to the corresponding side wall.

18. The method of claim 13, the first protection cover is a top protection cover for receiving a top section of a cellular phone and the second protection cover is a bottom protection cover for receiving a bottom section of a cellular phone, wherein the top protection cover has a first upper side and first lower side coupled to the first side rails and the bottom protection cover has a second upper side and second lower side coupled to the second side rails, lengths of the first upper side, first lower side, second upper side and second lower side being shorter than lengths of the first and second side rails.

19. The method of claim 18, wherein the top protection cover and the bottom protection cover maintain contact with each other when sliding with respect to each other.

20. The method of claim 18, wherein the first protection cover and the second protection cover are made of a substantially rigid material.
